(19) United States
(12) Patent Application Publication
(10) Pub. No.: US 2010/0275661 A1
(43) Pub. Date: Nov. 4, 2010

(54) Operational Device for Lock

(76) Inventor: Chung-Liang Lin, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/434,714

(22) Filed: May 4, 2009

(51) Int. Cl. E05B 65/00; E05B 7/00

(52) U.S. Cl. 70/91; 16/110.1

(57) ABSTRACT

A lock (20) includes an operational device (35) having a disc (112) mounted to an inner side (16) of a door (10). A sleeve (70) is rotatably received in the disc (112) and includes an axial hole (78) having non-circular cross sections that are not changed after rotating 180°. A linking rod (106) includes an inner end (110) engaged in a hole (24) of a drive member (22) in a case (21) mounted in the door (10). A cover (58) is mounted around the disc (112) and includes a pivot hole (64). A handle (38) includes a pivotal portion (40) and a drive portion (42) formed on an end face of the pivotal portion (40). The drive portion (42) has cross sections the same as the axial hole (78) of the sleeve (70). The pivotal portion is (40) pivotably received in the pivot hole (64) of the cover (58). The drive portion (42) is engaged in the axial hole (78) of the sleeve (70).

### BACKGROUND OF THE INVENTION

The present invention relates to an operational device for a lock and, more particularly, to an operational device for a lock to control opening and closing of a door to which the lock is mounted.

A wide variety of door locks is available in the market. In a type of the door locks, a latch of the lock is movably received in a case and can be retracted by an operational device outside of the case to provide versatile applications while enhancing security. In an example, the lock includes inner and outer handles coupled to inner and outer spindles. A spring device is attached to each of the inner and outer handles for returning the inner and outer handles. Each spring device includes a sleeve having an engaging piece. Each of the inner and outer handles is coupled to the sleeve of one of the spring devices and positioned by the engaging piece. Furthermore, each spring device includes a spring seat having a plurality of wings and a lug for limiting rotation of one of the inner and outer handles and for resisting torque. The wings and the lug are formed by bending a strip that forms each spring device such that the spring device includes a plurality of holes, leading to weakening of the structural strength of the spring seat. Furthermore, the engaging piece protrudes from an outer periphery of the sleeve in a specific orientation such that the inner or outer handle can only be coupled to the sleeve in a single orientation. Thus, when installing the lock on a differently handed door, the spring devices and the inner and outer handles must be rotated 180° to match with the case. As a result, the case must include four holes two of which are selected and extended through by two mounting posts. Similarly, each spring device must include four corresponding holes, leading to difficulties in lock designing. Specifically, the elements in the case must not extend or move through these holes regardless of their static or moving statuses.

Thus, a need exists for an operational device for a lock that allows easy designing of the lock while enhancing the structural strength.

### BRIEF SUMMARY OF THE INVENTION

The present invention solves this need and other problems in the field of operational devices by providing, in a preferred form, a lock including a case adapted to be mounted in a door having inner and outer sides. A latch is movable between an extended, locking position outside of the case and a retracted, unlocking position inside of the case. A drive member is rotatably received in the case and is operably connected to the latch so that rotation of the drive member moves the latch from the extended, locking position to the retracted, unlocking position. The drive member includes a hole. A first operational device includes a first disc adapted to be mounted to the inner side of the door. The first disc includes inner and outer surfaces spaced in an axial direction. A first bore extends from the inner surface through the outer surface of the first disc. The first operational device further includes a first sleeve including first and second ends spaced in the axial direction and an intermediate section between the first and second ends. The intermediate section of the first sleeve rotatably received in the first bore of the first disc. A first axial hole extends from the first end through the second end of the first sleeve. The first axial hole has non-circular cross sections that are not changed after rotating 180°. The first operational device further includes a first torsion spring mounted around the intermediate section of the first sleeve. The first operational device further includes a first linking rod including inner and outer ends spaced in the axial direction. The inner end of the first linking rod is engaged in the hole of the drive member. The first operational device further includes a first cover mounted around the first disc. The first cover includes inner and outer surfaces spaced in the axial direction and a peripheral surface extending between the inner and outer surfaces of the first cover. A first pivot hole extends from the inner surface through the outer surface of the first cover. The first pivot hole includes an inner periphery having a first annular groove intermediate the inner and outer surfaces of the first cover in the axial direction. The first operational device further includes a first handle including a first pivotal portion having an end face. A first drive portion is formed on the end face of the first pivotal portion. The first drive portion has cross sections the same as the first axial hole of the first sleeve. The first pivotal portion is pivotably received in the first pivot hole of the first cover. The first drive portion is engaged in the first axial hole of the first sleeve. The first operational device further includes a first pin mounted to the first pivotal portion of the first handle. The first pin and the first handle are jointly rotatable about the axial direction. When the first handle is rotated, the first sleeve and the first linking rod are rotated to rotate the drive member, moving the latch from the extended, locking position to the retracted, unlocking position and twisting the torsion spring for returning the first handle when the first handle is released.

In the most preferred form, a second operational device having a second handle is mounted to the outer side of the door.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a lock of an embodiment according to the preferred teachings of the present invention.

FIG. 2 shows a cross sectional view of the lock of FIG. 1 and a door to which the lock is mounted.

FIG. 2A shows an enlarged view of a circled portion in FIG. 2.

FIG. 3 shows a partial, side view of the door and the lock of FIG. 2.

FIG. 4 shows a partial, cross sectional view of the door and the lock of FIG. 2 according to section line 4-4 of FIG. 2.

FIG. 5 shows a partial, cross sectional view of the door and the lock of FIG. 2 according to section line 5-5 of FIG. 2.

FIG. 6 shows another cross sectional view of the lock of FIG. 2.

FIG. 7 shows a partial, exploded, perspective view of the lock of FIG. 1.

FIG. 8 shows a view similar to FIG. 5 with a handle rotated through an angle.

FIG. 9 shows a view similar to FIG. 2 with the lock in a state allowing free rotation of an outer handle.

FIG. 10 shows a lock of another embodiment according to the preferred teachings of the present invention.

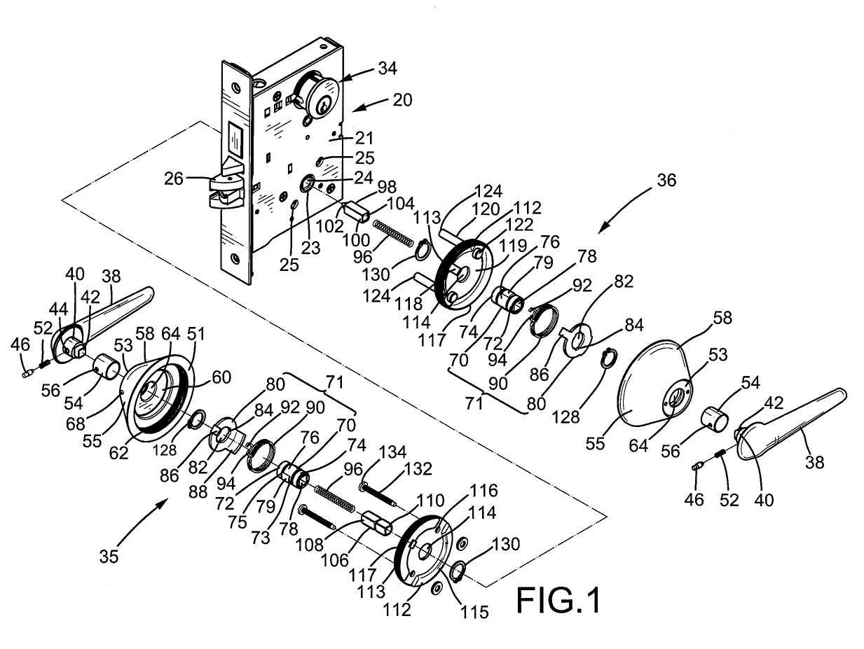

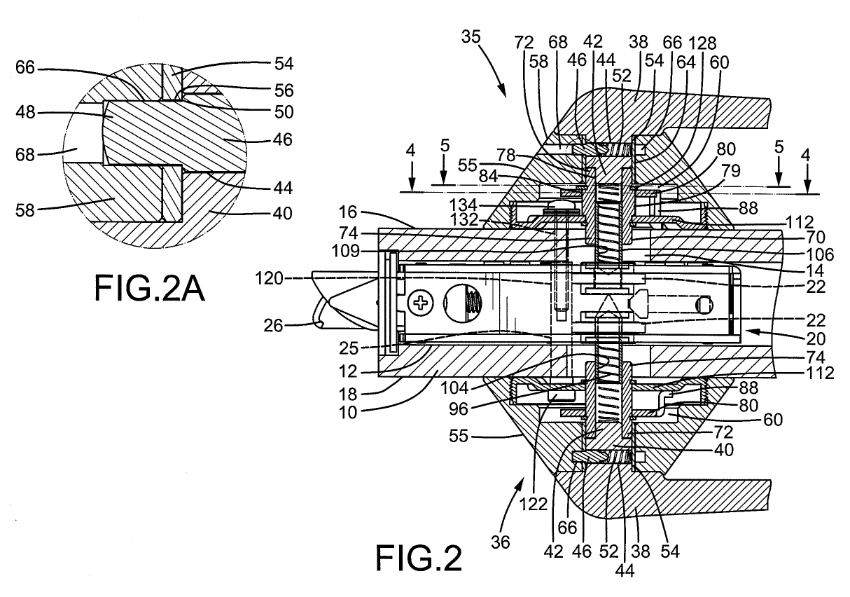

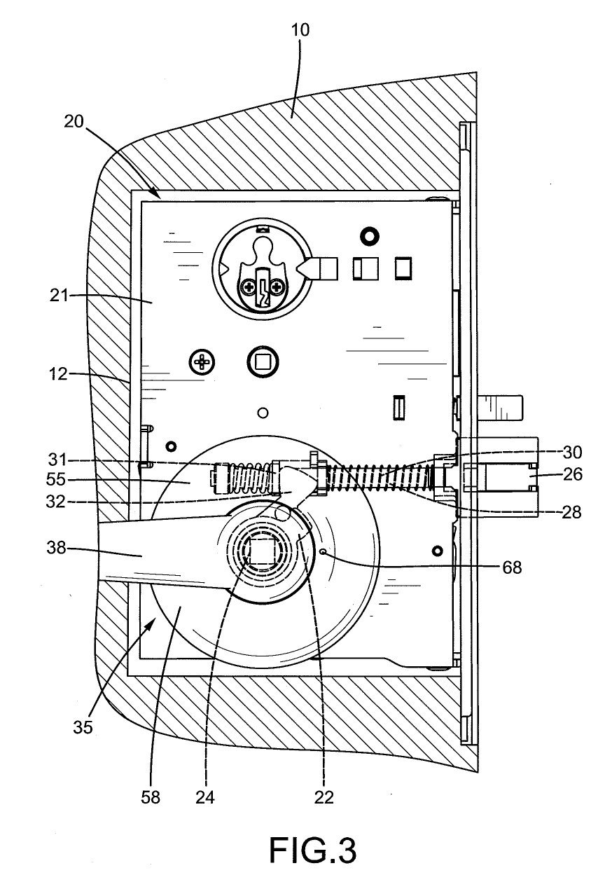

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “side”, “end”, “portion”, “section”, “axial”, “radial”, “circumferential”, “lateral”, “horizontal”, “annular”, “outward”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A lock according to the preferred teachings of the present invention is shown in the drawings and generally designated 20. Lock 20 is mounted to a door 10 having inner and outer sides 16 and 18 and a compartment 12 intermediate inner and outer sides 16 and 18. Each of inner and outer sides 16 and 18 includes an opening 14 in communication with compartment 12. Openings 14 are aligned with each other. Each of inner and outer sides 16 and 18 further includes two diametrically opposed installing holes spaced from opening 14 in a diametric direction. According to the preferred form shown, lock 20 includes a case 21 received in compartment 12 of door 10. Case 21 includes inner and outer lateral sides each having a hole 23 aligned with one of openings 14 and each having two mounting holes 25 diametrically arranged outside of hole 23. Mounting holes 25 are aligned with the installing holes of inner and outer sides 16 and 18 of door 10. Lock 20 further includes a key-operable cylinder 34 mounted to case 21. Lock 20 further includes a latch 26 coupled to a shank 28 slideably received in case 21. A follower 31 is mounted on shank 28, and a return spring 30 has an end pressing against follower 31 to bias latch 26 to an extended, locking position outside of case 21. Two drive members 22 are rotatably received in case 21 and spaced in an axial direction. Each drive member 22 includes a hole 24 aligned with one of holes 23. A mover 32 is mounted between and rotates jointly with drive members 22. When either drive member 22 is rotated, mover 32 presses against and moves shank 28 in a direction compressing return spring 30, retracting latch 26 to a retracted, unlocking position inside case 21.

According to the preferred form shown, lock 20 further includes a first operational device 35 mounted to inner side 16 of door 10 and a second operational device 36 mounted to outer side 18 of door 10. In the most preferred form shown, first operational device 35 and second operational devices 36 are substantially the same except some differences. Thus, description will be made with respect to first operational device 35 rather than both of first and second operational devices 35 and 36 to avoid redundancy. The differences between first and second operational devices 35 and 36 will be specifically set forth thereafter.

First operational device 35 includes a disc 112 having inner and outer surfaces 115 and 117 spaced in the axial direction. A bore 114 extends from inner surface 115 through outer surface 117 of disc 112 in the axial direction. Disc 112 further includes a threaded outer periphery 113 extending between inner surface 115 and outer surface 117. Disc 112 further includes two engaging holes 116 extending from inner surface 115 through outer surface 117 in the axial direction and radially outward of bore 114. Each engaging hole 116 is aligned with one of mounting holes 25 of one of inner and outer lateral sides of case 21. A projection 118 is formed on outer surface 117 of disc 112 and spaced from bore 114 in a radial direction perpendicular to the axial direction. Furthermore, projection 118 is intermediate engaging holes 116 in a circumferential direction about bore 114. Outer surface 117 of disc 112 includes a recessed portion 119. A blank can be punched to obtain disc 112 with a strip, and the strip can be bent to form projection 118.

According to the preferred form shown, first operational device 35 further includes a return mechanism 71 having a sleeve 70 pivotably received in bore 114 of disc 112. Specifically, sleeve 70 includes first and second ends 72 and 74 spaced in the axial direction and an intermediate section 76 between first and second ends 72 and 74. Intermediate section 76 includes two diametrically opposed protrusions 79 on an outer periphery thereof. Disc 112 is mounted around intermediate section 76. Sleeve 70 further includes an axial hole 78 extending from first end 72 through second end 74. Axial hole 78 has non-circular cross sections that are not changed after a phase change of 180°. Namely, the shape of the cross sections of axial hole 78 is the same as that of axial hole 78 after sleeve 70 is rotated 180°. Examples of the shape of the cross sections of axial hole 78 include, but not limited to, rectilinear, cruciform, square, hexagonal, octagonal, etc. Second end 74 of sleeve 70 is located outside of disc 112 and includes an annular groove 73 into which a retainer ring 130 is mounted.

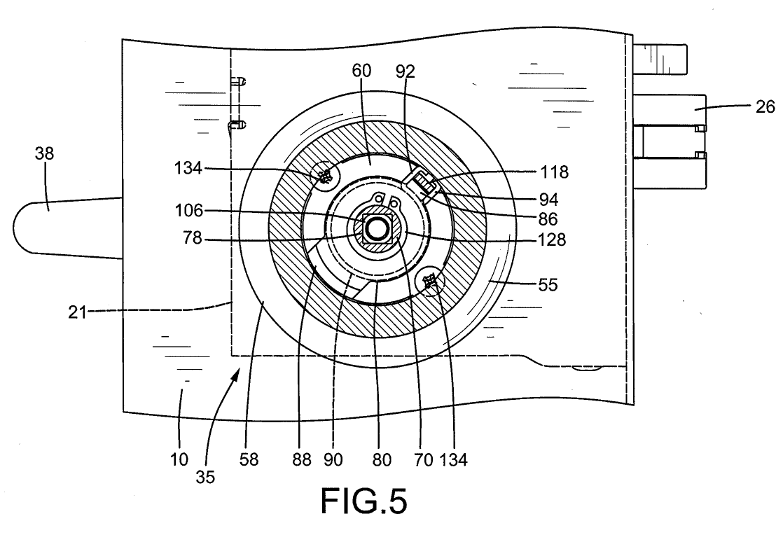

According to the preferred form shown, return mechanism 71 further includes a torsion spring 90 having first and second tangs 92 and 94. Torsion spring 90 is received in recessed portion 119 of disc 112 and around intermediate section 76 of sleeve 70. First and second tangs 92 and 94 abut against two sides of projection 118 of disc 112 (FIG. 5).

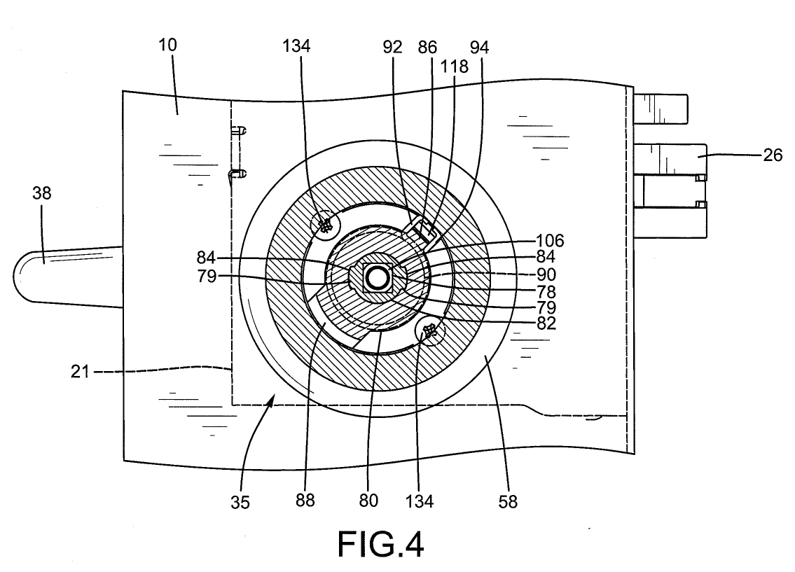

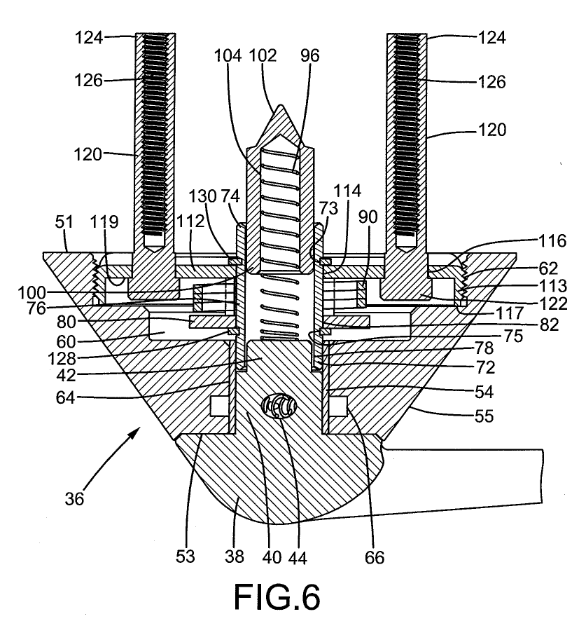

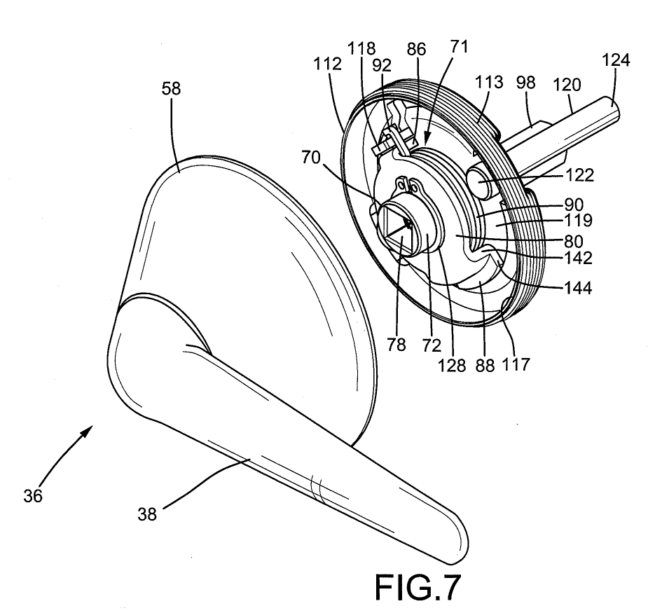

According to the preferred form shown, return mechanism 71 further includes a limiting member 80 in the form of a disc having a through-hole 82 having a longitudinal axis extending in the axial direction. Two diametrically opposed grooves 84 are formed in an inner periphery of the through-hole 82. Limiting member 80 further includes a lug 86 extending from an outer periphery thereof along a first axis parallel to and spaced from the longitudinal axis of through-hole 82. Limiting member 80 further includes an ear 88 diametrically opposed to lug 86. Ear 88 includes an axial section 142 extending from the outer periphery of limiting member 80 along a second axis parallel to and spaced from the longitudinal axis of through-hole 82. The second axis is parallel to and spaced from the first axis. Ear 82 further includes a radial section 144 extending from the distal end of axial section 142 in the radial direction. Limiting member 80 can be formed by punching and then bending a blank. Limiting member 80 is mounted around intermediate section 76 of sleeve 70 with through-hole 82 receiving intermediate section 76 and with protrusions 79 of sleeve 70 received in grooves 84 of limiting member 80, allowing joint rotation of limiting member 80 and sleeve 70. Furthermore, torsion spring 90 is intermediate disc 112 and limiting member 80 in the axial direction (FIG. 6). Lug 86 is intermediate first and second tangs 92 and 94 of torsion spring 90 (FIG. 4). A face of radial section 144 of ear 88 abuts outer surface 117 of disc 112 and intermediate engaging holes 116. A retainer ring 128 is mounted in another annular groove 75 in first end 72 of sleeve 70, preventing displacement of limiting member 80 in the axial direction. Thus, return mechanism 71 is pivotably positioned on disc 112 between retainer rings 128 and 130.

According to the preferred form shown, first operational device 35 further includes a linking rod 106 having a closed, inner end 110 and an open, outer end 108 spaced in the axial direction. Specifically, linking rod 106 includes a receptacle 109 that is open at outer end 108. Receptacle 109 has cross sections the same as axial hole 78 of sleeve 70. A spring 96 is received in receptacle 109. Outer end 108 of linking rod 106 is securely received in axial hole 78 of sleeve 70. An end of spring 96 abuts an end wall of receptacle 109 and biases linking rod 106 outward.

According to the preferred form shown, first operational device 35 further includes a cover 58 in the most preferred form shown as a truncated cone having inner and outer surfaces 51 and 53 spaced in the axial direction and a conical peripheral surface 55 extending between inner and outer surfaces 51 and 53. A pivot hole 64 extends from inner surface 51 through outer surface 53 in the axial direction. Pivot hole 64 includes an inner periphery having an annular groove 66 intermediate inner and outer surfaces 51 and 53 in the axial direction. A radial hole 68 extends from conical peripheral surface 55 to annular groove 66 in a radial direction perpendicular to the axial direction. Inner surface 51 includes a recess 60 having a bottom wall and a peripheral wall. The peripheral wall of recess 60 includes a threaded section 62 adjacent inner surface 51. The bottom wall of recess 60 is intermediate annular groove 66 and threaded section 62 in the axial direction.

According to the preferred form shown, first operational device 35 further includes a handle 38 pivotably coupled to cover 58. Handle 38 includes a pivotal portion 40 on an end thereof. Pivotal portion 40 includes a radial receptacle 44. A drive portion 42 is formed on an end face of pivotal portion 40 and has cross sections the same as axial hole 78 of sleeve 70. A pin 46 and a spring 52 are received in radial receptacle 44. Pin 46 includes a smaller, outer end 48, forming a shoulder 50. The other end of pin 46 has a maximum diameter larger than smaller, outer end 48 and abuts spring 52. Pivotal portion 40 and drive portion 42 of handle 38 are received in pivot hole 64 of cover 58. A ring 54 is mounted between pivotal portion 40 of handle 38 and the inner periphery of pivot hole 64 of cover 58. Ring 54 includes a limiting hole 56 extending in the radial direction and having a diameter smaller than radial receptacle 44 and smaller than shoulder 50 of pin 46. Limiting hole 56 is aligned with radial receptacle 44 and prevents pin 46 and spring 52 from disengaging from radial receptacle 44. However, smaller, outer end 48 of pin 46 extends beyond limiting hole 56 of ring 54 into annular groove 66 of cover 58, and shoulder 50 abuts an inner periphery of ring 54. Smaller, outer end 48 of pin 46 rotates in annular groove 66 of cover 58 when handle 38 is rotated. Thus, handle 38 is pivotable relative to cover 58 while preventing handle 38 from disengaging from pivot hole 64 in the axial direction. Threaded section 62 of cover 58 is threadedly engaged with threaded outer periphery 113 of disc 112, and drive portion 42 of handle 38 extends into axial hole 78 of first end 72 of sleeve 70. Thus, handle 38 and sleeve 70 can rotate jointly. Handle 38 is initially in a horizontal position under the action of return mechanism 71.

As mentioned above, first and second operational devices 35 and 36 of lock 20 according to preferred teachings of the present invention are substantially the same except some differences. The differences between first and second operational devices 35 and 36 will now be described. Specifically, two mounting posts 120 are mounted to engaging holes 116 of disc 112 of second operational device 36. Each mounting post 120 includes a first end 122 having a diameter larger than that of engaging holes 116 and a second end 124 having a diameter smaller than first end 122. Second end 124 of each mounting post 120 has a screw hole 126 aligned with one of mounting holes 25 of the inner lateral side of case 21. Disc 112 of first operational device 35 is mounted to inner side 16 of door 10, and disc 112 of second operational device 36 is mounted to outer side 18 of door 10. Second end 124 of each mounting post 120 is extended through one of engaging holes 116 of disc 112, through one of the installing holes of outer side 18 of door 10, and through one of mounting holes 25 of the outer lateral side of case 21 into case 21. First end 122 of each mounting post 120 is received in recessed portion 119 of disc 112. Note that each mounting post 120 is in tight fitting with one of engaging holes 116. Two bolts 132 are extended through mounting holes 116 of disc 112 of first operational device 35, through the installing holes of inner side 16 of door 10, and through mounting holes 25 of the inner lateral side of case 21 and into screw holes 126 of mounting posts 120.

Furthermore, in the most preferred form shown, cover 58 of second operational device 36 does not include radial hole 68 so that handle 38 on outer side 18 of door 10 can not be detached from outer side 18 of door 10. Mounting posts 120 can not be easily detached due to provision of disc 112. Thus, the whole second operational device 36 can not be easily detached from outer side 18 of door 10. Specifically, one must detach handle 38 of first operational device 35 and bolts 132 from inner side 16 of door 10 before detach second operational device 36. A burglarproof effect is, thus, provided. Detachment of handle 38 of first operational device 35 and bolts 132 can be accomplished as follows. An elongated tool is extended into radial hole 68 of cover 58 to push pin 46 into ring 54 so that handle 38 can be detached to expose bolts 132. First operational device 35 can be detached after removal of bolts 132, and second operational device 36 can be removed after removal of first operational device 35.

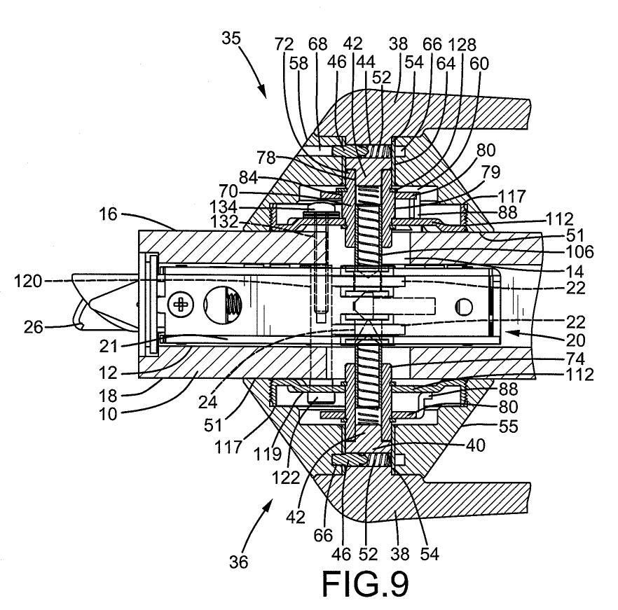

Further, in the most preferred form shown, second operational device 36 includes a linking rod 98 having an outer end 100 and a conic inner end 102 to provide a clutch function (FIG. 9) so that handle 38 of second operational device 36 rotates freely when desired. Specifically, operation of linking rod 98 of second operational device 36 is normally identical to linking rod 106 of first operational device 35 so that rotation of handle 38 of second operational device 36 causes retraction of latch 26 through linking rod 98. However, linking rod 98 can be moved, such as due to movement of a push member that actuates conic inner end 102 of linking rod 98 and moves linking rod 98, to disengage from hole 24 of one of drive members 22 so that rotation of handle 38 of second operational device 36 can not retract latch 26. An example of mechanisms with a clutch function is disclosed in U.S. Pat. No. 7,377,140, the entire contents of which are incorporated herein by reference. However, it can be appreciated that second operational device 36 can include linking rod 106 identical to that of first operational device 35 without providing the clutch function.

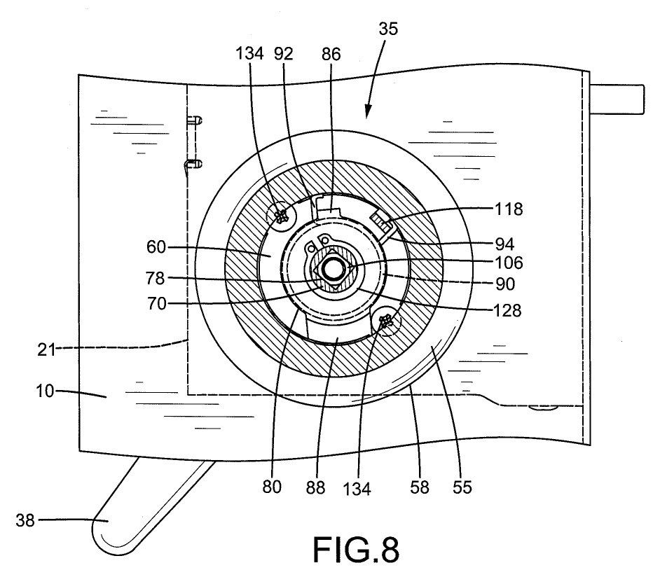

When handle 38 of first operational device 35 is rotated, sleeve 70 coupled to drive portion 42 is rotated to rotate limiting member 80 whose movement is stopped by a bolt head 134 of one of bolts 132 to limit rotation of handle 38 of first operational device 35. Specifically, handle 38 of first operational device 35 stops when radial section 144 of ear 88 of limiting member 80 of first operational device 35 comes in contact with bolt head 134 of one of bolts 132. Lug 86 of limiting member 80 presses against and moves first tang 92 of torsion spring 90 such that torsion spring 90 is twisted for returning purposes. Linking rod 106 is rotated to retract latch 26 from the extended, locking position to the retracted, unlocking position (FIG. 8). When handle 38 of first operational device 35 is released, handle 38 of first operational device 35 is returned to its horizontal state under the action of torsion spring 90.

Likewise, when handle 38 of second operational device 36 is rotated, sleeve 70 coupled to drive portion 42 is rotated to rotate limiting member 80 whose movement is stopped by first end 122 of one of mounting posts 120 to limit rotation of handle 38 of second operational device 36. Specifically, handle 38 of second operational device 36 stops when radial section 144 of ear 88 of limiting member 80 of second operational device 36 comes in contact with first end 122 of one of mounting posts 120. Lug 86 of limiting member 80 of second operational device 36 presses against and moves first tang 92 of torsion spring 90 such that torsion spring 90 is twisted for returning purposes. Linking rod 98 is rotated to retract latch 26 from the extended, locking position to the retracted, unlocking position (FIG. 8). When handle 38 of second operational device 36 is released, handle 38 of second operational device 36 is returned to its horizontal state under the action of torsion spring 90.

Due to the structures of first and second operational devices 35 and 36, covers 58 do not have to be assembled with discs 112 during sale. Specifically, each cover 58 can only be assembled to one of handles 38, and each disc 112 can only be assembled to one of return mechanisms 71. Thus, handles 38 can rotate freely relative to covers 58, allowing easy installation by an installer according to the environment and the hand of the door by rotating the handles 38 to the desired orientations. Furthermore, since the rotational movement of handle 38 of first operational device 35 is limited by bolt heads 134 of bolts 132 and since the rotational movement of handle 38 of second operational device 36 is limited by first ends 122 of mounting posts 120, discs 112 can be easily formed without the need of forming stops for the purposes of limiting the rotational movement of handles 38. Furthermore, the number of holes in discs 112 can be reduced to the minimum, providing discs 112 with sufficient structural strength.

It can be appreciated that sleeves 70 have the same cross sectional shapes after rotating 180°, such that handles 38 are still coupled to sleeves 70 after rotating 180°. Thus, the engaging relationship between discs 112 and case 21 does not have to be changed when installing lock 20 on differently handed doors. Provision of two mounting holes 25 in each lateral side of case 21 of lock 20 is sufficient, allowing various designs of lock 20.

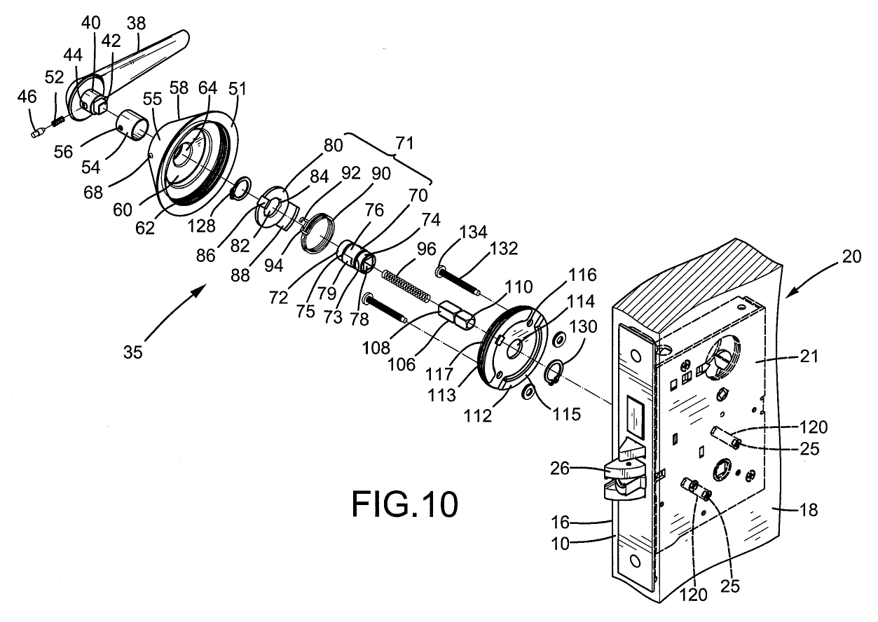

Lock 20 does not have to include second operational device 36 in some applications. As an example, lock 20 can include a fixed handle fixed to outer side 18 of door 10. Unlocking from outer side 18 can only be achieved by using a key to operate cylinder 34. In a further simplified application, lock 20 does not include cylinder 34, such that door 10 can be unlocked by operating first operational device 35 from inner side 16 of door 10 (FIG. 10). In cases that only first operational device 35 is utilized, mounting posts 120 are mounted in case 21 and located between mounting holes 25 of the lateral sides of case 21. Each mounting post 120 can include an end coupled in one of mounting holes 25 of the outer lateral side of case 21. Furthermore, case 21 does not have to include one of drive members 22 adjacent the outer lateral side of case 21.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A lock comprising, in combination:
a case (21) adapted to be mounted in a door (10), with the door (10) having inner and outer sides (16, 18);
a latch (26) movable between an extended, locking position outside of the case (21) and a retracted, unlocking position inside of the case (21);
a first drive member (22) rotatably received in the case (21), with the first drive member (22) operably connected to the latch (26) so that rotation of the first drive member (22) moves the latch (26) from the extended, locking position to the retracted, unlocking position, with the first drive member (22) including a first hole (24); and
a first operational device (35) including:
a first disc (112) adapted to be mounted to the inner side (16) of the door (10), with the first disc (112) including inner and outer surfaces (115, 117) spaced in the axial direction, with a first bore (114) extending from the inner surface (115) through the outer surface (117) of the first disc (112);
a first sleeve (70) including first and second ends (72, 74) spaced in the axial direction and an intermediate section (76) between the first and second ends (72, 74), with the intermediate section (76) of the first sleeve (70) rotatably received in the first bore (114) of the first disc (112), with a first axial hole (78) extending from the first end (72) through the second end (74) of the first sleeve (70), with the first axial hole (78) having non-circular cross sections that are not changed after rotating 180°;
a first torsion spring (90) mounted around the intermediate section (76) of the first sleeve (70);
a first linking rod (106) including inner and outer ends (110, 108) spaced in the axial direction, with the inner end (110) of the first linking rod (106) engaged in the first hole (24) of the first drive member (22);
a first cover (58) mounted around the first disc (112), with the first cover (58) including inner and outer surfaces (51, 53) spaced in the axial direction and a peripheral surface (55) extending between the inner and outer surfaces (51, 53) of the first cover (58), with a first pivot hole (64) extending from the inner surface (51) through the outer surface (53) of the first cover (58), with the first pivot hole (64) including an inner periphery having a first annular groove (66) intermediate the inner and outer surfaces (51, 53) of the first cover (58) in the axial direction;
a first handle (38) including a first pivotal portion (40) having an end face, with a first drive portion (42) formed on the end face of the first pivotal portion (40), with the first drive portion (42) having cross sections the same as the first axial hole (78) of the first sleeve (70), with the first pivotal portion (40) pivotably received in the first pivot hole (64) of the first cover (58), with the first drive portion (42) engaged in the first axial hole (78) of the first sleeve (70);
a first pin (46) mounted to the first pivotal portion (40) of the first handle (38), with the first pin (46) and the first handle (38) jointly rotatable about the axial direction,
wherein when the first handle (38) is rotated, the first sleeve (70) and the first linking rod (106) are rotated to rotate the first drive member (22), moving the latch (26) from the extended, locking position to the retracted, unlocking position and twisting the first torsion spring (90) for returning the first handle (38) when the first handle (38) is released.

2. The lock as claimed in claim 1, with the first cover (58) including a first radial hole (68) extending from the peripheral surface (55) to the first annular groove (66) in a radial direction perpendicular to the axial direction, with the first pivotal portion (40) further including a first radial receptacle (44) extending in the radial direction, with the first radial receptacle (44) aligned with the first radial hole (68), with the first pin (46) slideably received in the first receptacle (44) of the first pivotal portion (40) of the first handle (38) in the radial direction, and with a first spring (52) received in the first radial receptacle (44) and biasing the first pin (46) into the first radial hole (68) of the first cover (58), preventing the first handle (38) from disengaging from the first pivot hole (64) in the axial direction while allowing the first handle (38) to pivot relative to the first cover (58).

3. The lock as claimed in claim 2, further comprising, in combination: a first ring (54) mounted between the first pivotal portion (40) of the first handle (38) and an inner periphery of the first pivot hole (64) of the first cover (58), with the first pin (46) including a smaller, outer end (48), forming a shoulder (50), with the first ring (54) including a limiting hole (56) extending in the radial direction and having a diameter smaller than the first radial receptacle (44) and smaller than the shoulder (50) of the first pin (46), and with the first spring (52) biasing the smaller, outer end (48) beyond the limiting hole (56) into the first annular groove (66) of the first cover (58) so that the smaller, outer end (48) of the first pin (46) rotates in the first annular groove (66) of the first cover (58) when the first handle (38) is rotated.

4. The lock as claimed in claim 3, further comprising, in combination: a first limiting member (80) including a through-hole (82) receiving the intermediate section (76) of the first sleeve (70), with the first torsion spring (90) intermediate the first limiting member (80) and the first disc (112) in the axial direction, with the intermediate section (76) of the first sleeve (70) including two diametrically opposed protrusions (79), with the through-hole (82) of the first limiting member (80) including two diametrically opposed grooves (84) securely receiving the two protrusions (79) of the first sleeve (70), allowing joint rotation of the first sleeve (70) and the first limiting member (80), with the first torsion spring (90) having first and second tangs (92, 94), with the first limiting member (80) further including a first lug (86) intermediate the first and second tangs (92, 94) of the first torsion spring (90), and with the first lug (86) pressing against the first tang (92) of the first torsion spring (90) and twisting the first torsion spring (90) when the first handle (38) is rotated.

5. The lock as claimed in claim 4, further comprising, in combination:
first and second mounting posts (120) mounted in the case (21), with each of the first and second mounting posts (120) having first and second ends (122, 124), with the second end (124) of each of the first and second mounting posts (120) including a screw hole; and
first and second bolt (132) extending through the first disc (112) in the axial direction and through the case (21) into the screw holes of the first and second mounting posts (120).

6. The lock as claimed in claim 5, with the outer surface (117) of the first disc (112) including a recessed portion (119), and with each of the first and second bolts (132) having a bolt head (134) received in the recessed portion (119).

7. The lock as claimed in claim 6, with the first disc (112) having a threaded outer periphery (113) extending between the inner and outer surfaces (115, 117) of the first disc (112), with the first disc (112) further including a first projection (118) formed on the threaded outer periphery (113) and spaced from the first bore (114) in the radial direction, with the first and second tangs (92, 94) of the first torsion spring (90) abutting two sides of the first projection (118), with the inner surface (51) of the first cover (58) including a recess (60) having a threaded section (62) threadedly engaged with the threaded outer periphery (113) of the first disc (112), with the recess (60) having a button wall intermediate the first annular groove (66) and the threaded section (62) in the axial direction, and with the first limiting member (80) rotatably received in the recess (60) of the first cover (58).

8. The lock as claimed in claim 7, with the first limiting member (80) further including a first ear (88), with the first ear (88) coming in contact with the bolt head (134) of one of the first and second bolts (132) when the first handle (38) is rotated through an angle, preventing further rotation of the first handle (38).

9. The lock as claimed in claim 8, with the through-hole (82) of the first limiting member (80) including a longitudinal axis extending in the axial direction, with the first ear (88) including a first axial section (142) extending along an axis parallel to and spaced from the longitudinal axis of the through-hole (82) of the first limiting member (80), with the first ear (88) further includes a first radial section (144) extending from a distal end of the first axial section (142) in the radial direction, with the first radial section (144) of the first ear (88) coming in contact with the bolt head (134) of one of the first and second bolts (132) when the first handle (38) is rotated through the angle, preventing further rotation of the first handle (38).

10. The lock as claimed in claim 9, further comprising, in combination: a second operational device (36) comprising:
a second disc (112) adapted to be mounted to the outer side (18) of the door (10), with the second disc (112) including inner and outer surfaces (115, 117) spaced in the axial direction, with a second bore (114) extending from the inner surface (115) through the outer surface (117) of the second disc (112);
a second sleeve (70) including first and second ends (72, 74) spaced in the axial direction and an intermediate section (76) between the first and second ends (72, 74), with the intermediate section (76) of the second sleeve (70) rotatably received in the second bore (114) of the second disc (112), with a second axial hole (78) extending from the first end (72) through the second end (74) of the second sleeve (70), with the second axial hole (78) having non-circular cross sections that are not changed after rotating 180°;
a second torsion spring (90) mounted around the intermediate section (76) of the second sleeve (70);
a second linking rod (98) including inner and outer ends (102, 100) spaced in the axial direction, with a second drive member (22) rotatably received in the case (21) and spaced from the first drive member (22) in the axial direction, with the second drive member (22) operably connected to the latch (26) so that rotation of the second drive member (22) moves the latch (26) from the extended, locking position to the retracted, unlocking position, with the second drive member (22) including a second hole (24), with the inner end (102) of the second linking rod (98) engaged in the second hole (24) of the second drive member (22);
a second cover (58) mounted around the second disc (112), with the second cover (58) including inner and outer surfaces (51, 53) spaced in the axial direction and a peripheral surface (55) extending between the inner and outer surfaces (51, 53) of the second cover (58), with a second pivot hole (64) extending from the inner surface (51) through the outer surface (53) of the second cover (58), with the second pivot hole (64) including an inner periphery having a second annular groove (66) intermediate the inner and outer surfaces (51, 53) of the second cover (58) in the axial direction;
a second handle (38) including a second pivotal portion (40) having an end face, with a second drive portion (42) formed on the end face of the second pivotal portion (40), with the second drive portion (42) having cross sections the same as the second axial hole (78) of the second sleeve (70), with the second pivotal portion (40) pivotably received in the second pivot hole (64) of the second cover (58), with the second drive portion (42) engaged in the second axial hole (78) of the second sleeve (70);
a second pin (46) mounted to the second pivotal portion (40) of the second handle (38), with the second pin (46) and the second handle (38) jointly rotatable about the axial direction,
wherein when the second handle (38) is rotated, the second sleeve (70) and the second linking rod (98) are rotated to rotate the second drive member (22), moving the latch (26) from the extended, locking position to the retracted, unlocking position and twisting the second torsion spring (90) for returning the second handle (38) when the second handle (38) is released.

11. The lock as claimed in claim 10, with the second pivotal portion (40) further including a second radial receptacle (44) extending in the radial direction, with the second pin (46) slideably received in the second radial receptacle (44) of the second pivotal portion (40) of the second handle (38) in the radial direction, and with a second spring (52) received in the second receptacle (44) and biasing the second pin (46) into the second annular groove (66) of the second cover (58), preventing the second handle (38) from disengaging from the second pivot hole (64) in the axial direction while allowing the second handle (38) to pivot relative to the second cover (58).

12. The lock as claimed in claim 11, further comprising, in combination: a second ring (54) mounted between the second pivotal portion (40) of the second handle (38) and an inner periphery of the second pivot hole (64) of the second cover (58), with the second pin (46) including a smaller, outer end (48), forming a shoulder (50), with the second ring (54) including a limiting hole (56) extending in the radial direction and having a diameter smaller than the second radial receptacle (44) and smaller than the shoulder (50) of the second pin (46), and with the second spring (52) biasing the smaller, outer end (48) beyond the limiting hole (56) into the second annular groove (66) of the second cover (58) so that the smaller, outer end (48) of the second pin (46) rotates in the second annular groove (66) of the second cover (58) when the second handle (38) is rotated.

13. The lock as claimed in claim 12, further comprising, in combination: a second limiting member (80) including a through-hole (82) receiving the intermediate section (76) of the second sleeve (70), with the second torsion spring (90) intermediate the second limiting member (80) and the second disc (112) in the axial direction, with the intermediate section (76) of the second sleeve (70) including two diametrically opposed protrusions (79), with the through-hole (82) of the second limiting member (80) including two diametrically opposed grooves (84) securely receiving the two protrusions (79) of the second sleeve (70), allowing joint rotation of the second sleeve (70) and the second limiting member (80), with the second torsion spring (90) having first and second tangs (92, 94), with the second limiting member (80) further including a second lug (86) intermediate the first and second tangs (92, 94) of the second torsion spring (90), and with the second lug (86) pressing against the first tang (92) of the second torsion spring (90) and twisting the second torsion spring (90) when the second handle (38) is rotated.

14. The lock as claimed in claim 13, with the outer surface (117) of the second disc (112) including a recessed portion (119), and with the first end (122) of each of the first and second mounting posts (120) received in the recessed portion (119).

15. The lock as claimed in claim 14, with the second disc (112) having a threaded outer periphery (113) extending between the inner and outer surfaces (115, 117) of the second disc (112), with the second disc (112) further including a second projection (118) formed on the threaded outer periphery (113) and spaced from the second bore (114) in the radial direction, with the first and second tangs (92, 94) of the second torsion spring (90) abutting two sides of the second projection (118), with the inner surface (51) of the second cover (58) including a recess (60) having a threaded section (62) threadedly engaged with the threaded outer periphery (113) of the second disc (112), with the recess (60) having a button wall intermediate the second annular groove (66) and the threaded section (62) in the axial direction, and with the second limiting member (80) rotatably received in the recess (60) of the second cover (58).

16. The lock as claimed in claim 15, with the second limiting member (80) further including a second ear (88), with the second ear (88) coming in contact with the first end (122) of one of the first and second mounting posts (120) when the second handle (38) is rotated through an angle, preventing further rotation of the second handle (38).

17. The lock as claimed in claim 16, with the through-hole (82) of the second limiting member (80) including a longitudinal axis extending in the axial direction, with the second ear (88) including a second axial section (142) extending along an axis parallel to and spaced from the longitudinal axis of the through-hole (82) of the second limiting member (80), with the second ear (82) further includes a second radial section (144) extending from a distal end of the second axial section (142) in the radial direction, with the second radial section (144) of the second ear (88) coming in contact first end (122) of one of the first and second mounting posts (120) when the second handle (38) is rotated through the angle, preventing further rotation of the second handle (38).

18. The lock as claimed in claim 1, further comprising, in combination:
first and second mounting posts (120) mounted in the case (21), with each of the first and second mounting posts (120) having first and second ends (122, 124), with the second end (124) of each of the first and second mounting posts (120) including a screw hole;
first and second bolts (132) extending through the first disc (112) in the axial direction and through the case (21) into the screw holes of the first and second mounting posts (120); and
a second operational device (36) comprising:
a second disc (112) adapted to be mounted to the outer side (18) of the door (10), with the second disc (112) including inner and outer surfaces (115, 117) spaced in the axial direction, with a second bore (114) extending from the inner surface (115) through the outer surface (117) of the second disc (112);
a second sleeve (70) including first and second ends (72, 74) spaced in the axial direction and an intermediate section (76) between the first and second ends (72, 74), with the intermediate section (76) of the second sleeve (70) rotatably received in the second bore (114) of the second disc (112), with a second axial hole (78) extending from the first end (72) through the second end (74) of the second sleeve (70), with the second axial hole (78) having non-circular cross sections that are not changed after rotating 180°;
a second torsion spring (90) mounted around the intermediate section (76) of the second sleeve (70);
a second linking rod (98) including inner and outer ends (102, 100) spaced in the axial direction, a second drive member (22) rotatably received in the case (21) and spaced from the first drive member (22) in the axial direction, with the second drive member (22) operably connected to the latch (26) so that rotation of the second drive member (22) moves the latch (26) from the extended, locking position to the retracted, unlocking position, with the second drive member (22) including a second hole (24), with the inner end (102) of the second linking rod (98) engaged in the second hole (24) of the second drive member (22);
a second cover (58) mounted around the second disc (112), with the second cover (58) including inner and outer surfaces (51, 53) spaced in the axial direction and a peripheral surface (55) extending between the inner and outer surfaces (51, 53) of the second cover (58), with a second pivot hole (64) extending from the inner surface (51) through the outer surface (53) of the second cover (58), with the second pivot hole (64) including an inner periphery having a second annular groove (66) intermediate the inner and outer surfaces (51, 53) of the second cover (58) in the axial direction,;
a second handle (38) including a second pivotal portion (40) having an end face, with a second drive portion (42) formed on the end face of the second pivotal portion (40), with the second drive portion (42) having cross sections the same as the second axial hole (78) of the second sleeve (70), with the second pivotal portion (40) pivotably received in the second pivot hole (64) of the second cover (58), with the second drive portion (42) engaged in the second axial hole (78) of the second sleeve (70);
a second pin (46) mounted to the second pivotal portion (40) of the second handle (38), with the second pin (46) and the second handle (38) jointly rotatable about the axial direction,
wherein when the second handle (38) is rotated, the second sleeve (70) and the second linking rod (98) are rotated to rotate the second drive member (22), moving the latch (26) from the extended, locking position to the retracted, unlocking position and twisting the second torsion spring (90) for returning the second handle (38) when the second handle (38) is released.

19. The lock as claimed in claim 18, with the first cover (58) including a first radial hole (68) extending from the peripheral surface (55) to the first annular groove (66) in a radial direction perpendicular to the axial direction, with the first pivotal portion (40) further including a first radial receptacle (44) extending in the radial direction, with the first radial receptacle (44) aligned with the first radial hole (68), with the first pin (46) slideably received in the first radial receptacle (44) of the first pivotal portion (40) of the first handle (38) in the radial direction, and with a first spring (52) received in the first receptacle (44) and biasing the first pin (46) into the first radial hole (68) of the first cover (58), preventing the first handle (38) from disengaging from the first pivot hole (64) in the axial direction while allowing the first handle (38) to pivot relative to the first cover (58).

20. The lock as claimed in claim 19, further comprising, in combination: a first ring (54) mounted between the first pivotal portion (40) of the first handle (38) and an inner periphery of the first pivot hole (64) of the first cover (58), with the first pin (46) including a smaller, outer end (48), forming a shoulder (50), with the first ring (54) including a limiting hole (56) extending in the radial direction and having a diameter smaller than the first radial receptacle (44) and smaller than the shoulder (50) of the first pin (46), and with the first spring (52) biasing the smaller, outer end (48) beyond the limiting hole (56) into the first annular groove (66) of the first cover (58) so that the smaller, outer end (48) of the first pin (46) rotates in the first annular groove (66) of the first cover (58) when the first handle (38) is rotated.
